(19) United States
(12) Patent Application Publication
(10) Pub. No.: US 2009/0194925 A1
(43) Pub. Date: Aug. 6, 2009

(54) CORK CUTTING BOARD AND METHOD OF MAKING

(76) Inventor: David R. Rolf, Delray Beach, FL (US)

Correspondence Address: MALIN HALEY AND DIMAGGIO, PA, 1936 S ANDREWS AVENUE, FORT LAUDERDALE, FL, 33316, US

(21) Appl. No.: 12/363,972

(22) Filed: Feb. 2, 2009

Related U.S. Application Data
(60) Provisional application No. 61/025,942, filed on Feb. 4, 2008.

(51) Int. Cl. B23Q 3/00

(52) U.S. Cl. 269/302.1

(57) ABSTRACT

A food cutting board, said cutting board having at least one flat surface composed entirely of a high density cork composite material.

### BACKGROUND OF THE INVENTION

1. Field of the Invention

The present invention relates generally to an apparatus upon which food items are cut and prepared and, specifically, to a cutting board made from a cork material and the method of making.

2. Description of Related Art

Cutting boards are used to protect the surface that the cutting board rests on from damage caused by the cutting and preparation of food such as vegetables and meats. Primarily, two parameters, the deformation resistance and the porosity are used to measure the performance level of a cutting board. Deformation resistance is important in limiting the amount of damage to the board after continued use. The level of porosity determines how much bacteria becomes trapped in the board over time. The ideal cutting board is extremely resistant to deformation with a low porosity level. Also, cutting boards should be able to be placed in a dishwasher and subject to high water temperatures for destroying bacteria.

Traditionally, cutting boards are made out of wood, plastic or granite. Both wood and granite advantageously have a high resistance to deformation, but also have high porosity. The high porosity of wood and granite make traditional boards susceptible to contamination with continued use. Recently carving boards are being made out of hard plastics. The plastics used in the manufacture of these boards have an extremely low porosity, but also a low deformation resistance. Boards made from hard plastic are prone to large cutting marks and increased wear due to the low deformation resistance of the materials that comprise the boards.

U.S. Pat. No. 6,994,335 issued to Porchia et al. describes a disposable cutting board utilizing a stacked multi-layer design. The stacked design includes an absorbent layer superimposed on top of a corrugated layer. The corrugated layer is protected with a backing layer that limits the movement of the board while lying on a flat surface. The absorbent layer can be manufactured from a number of materials including cork. The cork layer is used primarily to absorb the liquids generated by the foods that are prepared on the board and not to provide a layer that is resistant to the deformation caused by repeated use. U.S. Pat. No. 5,992,035 issued to Otsu, describes an ornamental cutting and serving board made from a ceramic material. The back side of the ceramic board is covered with a cork layer. The cork layer is used as a damper plate to prevent the ceramic layer from breaking or creating loud noises when coming in contact with other surfaces. Furthermore, the cork layer is not used as a surface upon which food items are prepared.

Cork, when manufactured in a high density form with a polymetric urethane base, provides a deformation resistant material that is naturally antibacterial. The material characteristics of high density cork make it ideal for the manufacturer of cutting boards.

The advantage of using cork also is beneficial to the environment. The cork used in the present invention is actually constructed from the bark of the cork tree. New bark grows back after the bark is removed from the tree. Therefore, from an environmental standpoint, cork trees are not destroyed in the manufacture of a cork cutting board but are, in fact, kept alive. The bark material is renewable because the bark grows back. This is an environmentally sound practice to use a material that renews itself. At the same time, the tree provides oxygen to the surrounding environment while consuming carbon dioxide.

### SUMMARY OF INVENTION

A cutting board for cutting and preparing food such as vegetables and meat manufactured from the bark of a cork tree and a polymetric urethane base. The cutting board is molded, pressed and cut to provide a flat top surface upon which the preparation of food including cutting is performed. The cork cutting board provides a top cutting surface that is resistant to deformation from sharp objects such as knives. The cork cutting board also provides a bottom surface that rests against the surface that the board is placed on.

Working surface, in this definition, includes a cutting surface. The cork composite cutting board may have a hole through the high density cork layer body used to hang the board that is located next to an edge of the board. The cork perimeter forming the hole is covered with a metal layer to enable the hanging of the board.

The present invention also includes the manufacture of the cork cutting board. The cork composite material is prepared by taking the bark of a cork tree and grinding the bark into granules of different sizes. The cork particles density is separated, the objective being to create a high density product. Once the density of the cork particles or granules has been selected, the cork is mixed with a polymetric urethane. The slurry is then placed in a large mold and subjected to high pressure so that a block of high density cork composite material is produced which is then placed in an oven for 72 hours for drying. The oven kills any bacteria in the material and the large block of mold cork composite material is ready for cutting and smoothing into different sized cutting boards of different or the same thickness.

There is a large spectrum of density values for the mixture of cork granules and polymetric urethane with the objective being to create a composite that has a high resistance to deformation and a low porosity to prevent bacteria buildup within the board itself.

It is, therefore, an object of the present invention to provide a portable flat cutting used for food preparation and presentation, the board being comprised of a cork composite material that has a high resistance to deformation.

Another object of this invention is to provide a portable flat board for the use of food preparation and presentation, which is comprised of a cork composite material that limits the accumulation of bacteria on the working surface.

It is yet another object of this invention to provide a portable flat board for the use of food preparation and presentation, which is constructed from a recyclable environmentally stable cork material.

It is a further object of this invention to provide a portable flat cork cutting board for the use of food preparation and presentation that creates a high coefficient of friction between the board and the surface that it rests on, thus limiting the movement of the board during operation.

It is another object of this invention to provide a flat cork cutting board for the use of food preparation and presentation which can be stored by hanging.

These and other objects and advantages of the present invention will become apparent in the drawings and the accompanying description set forth hereinafter.

### BRIEF DESCRIPTION OF THE DRAWINGS

FIG. 1 shows a top plan view of the cork composite cutting board.

FIG. 2 shows an elevational side view of the cork composite cutting board.

### PREFERRED EMBODIMENT OF THE INVENTION

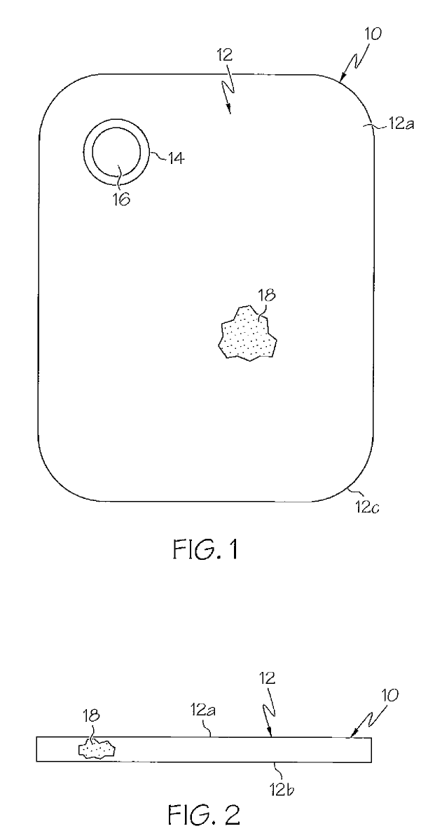

Referring now to the drawings and, in particular, FIG. 1, a top plan view of a cork cutting board 10 is shown. The composite cork material is shown as element 18. The board 10 is made entirely of composite cork 18 described herein. The cutting board 10 is rectangular in shape and manufactured by a process described herein and includes body 12. The body 12 is comprised of a flat a top surface 12a, a flat bottom surface 12b and four linear sides, two of which are generally shorter than the other two. The flat sides are connected using rounded edges 12c. The cutting board body 12 includes a top side cutting surface 12a, a circular aperture 16, and the metal aperture sleeve 14. The top side cutting surface 12a is defined in shape by the linear sides of the cutting board 10. The cutting board 10 is composed of a high density cork composite material. The circular aperture 16 extends through the cutting board 10 and is used for hanging the board on a hook or nail. Objects such as hooks are placed through the aperture 16 to support the weight of the cutting board 10. The body aperture metal sleeve 14 can be a metal, a plastic, or any other suitable material. The metal sleeve 14 is attached to all the inside and peripheral areas of aperture 16 and serves to protect the high density cork composite material.

The high density cork composite material 18 that is used to construct the cutting board 10 is both extremely resistant to deformation and naturally antibacterial. The high deformation resistance of the cork material makes the top cutting surface 12a of the cutting board 10 resilient to damage caused by the impact of knife blade pressure applied to the top surface 12a on the board. The low porosity of the cork material limits the amount of bacteria that is trapped in the board over time. Furthermore, the high density cork material naturally contains suberin which is impermeable to the gases and liquids that transport bacteria into the cutting boards. Both the suberin and the low porosity contribute to limiting the amount of bacteria that exists on and within the front side cutting surface 12 of the cutting board 10.

The high density cork material is created with cork that is harvested from the bark of cork trees. Harvesting the bark of cork trees does not kill the tree and can be performed multiple times during the lifetime of the tree, due to the its rejuvenation ability. The process of harvesting cork from existing trees saves many trees that are able to produce oxygen and consume harmful greenhouse gasses. Furthermore, cork is a recyclable material allowing used cork boards to be manufactured into a number of items such as floor tiles, sports equipment, or shoes. The use of a cork in cutting boards is an environmentally friendly process that encourages the preservation of natural habitats.

The present invention also includes the manufacture of the cork cutting board. The cork composite material is prepared by taking the bark of a cork tree and grinding the bark into granules of different sizes. The cork particles density is separated and the objective being to create a high density product. Once the density of the cork particles has been selected, there is a slurry created with a polymetric urethane that is mixed in with the ground up cork particles. The slurry is then placed in a large mold and subjected to high pressure so that a sheet of material is produced which is then placed in an oven for several hours for drying. The oven kills any bacteria in the material and the boards are then ready for cutting and smoothing into different sized cutting boards.

There is a large spectrum of values for the mixture of cork granules in polymer-metric urethane base with the objective being to create a composite that has a high resistance deformation and a low porosity to prevent bacteria buildup within the board itself.

Referring now to both FIGS. 1 and 2, a side view of the cork board 10 is shown. The cork board 10 is comprised of both a top cutting surface 12a and a bottom side surface 12b. Both the top cutting surface 12 and bottom surface 12b are formed as is the entire body 12 of pressed high density cork composite material. Furthermore, both top and bottom surfaces 12a and 12b can be used as areas to perform the desired cutting functions on. The high density cork material used to construct the cutting board 10 forms a high coefficient of friction between most surfaces. The use of opposing cutting surfaces ensures that a cork side is always in contact with the surface that the board is resting upon. Thus, movement of the board during operation is limited because of the high amount of friction that forms between the bottom cork cutting surface 12b and the surface that the cutting board 10 rest on,

What is claimed is,

1. A cutting board comprising:
a body composed of a high density cork material having at least one flat cutting surface.

2. A cutting board comprising:
a cork body;
said body having a flat planar surface that forms a first cutting side that is composed of a high density cork material; and
a body having an aperture between said first cutting side and the opposing side for hanging said board.

3. A cutting board comprising:
a pressed cork body;
said body having a flat planar surface that forms a cutting side that is composed of a high density cork material; and
the opposite side of said cutting side also forming a second flat cutting side that is composed of a high density cork material.
